(19) United States
(12) Patent Application Publication
(10) Pub. No.: US 2025/0259773 A1
(43) Pub. Date: Aug. 14, 2025

(54) Coupled Inductor

(71) Applicant: CYNTEC CO., LTD., Hsinchu (TW)

(72) Inventors: Sen-Huei Chen, Hsinchu (TW); Chi-Shiuan Shie, Hsinchu (TW); I-An Chen, Hsinchu (TW)

(73) Assignee: CYNTEC CO., LTD., Hsinchu (TW)

(21) Appl. No.: 19/192,301

(22) Filed: Apr. 28, 2025

Related U.S. Application Data
(63) Continuation-in-part of application No. 18/918,160, filed on Oct. 17, 2024.
(60) Provisional application No. 63/649,331, filed on May 18, 2024.
(60) Provisional application No. 63/544,450, filed on Oct. 17, 2023.

(51) Int. Cl. H01F 27/02; H01F 27/24; H01F 27/28; H01F 27/29; H01F 27/32

(52) U.S. Cl. CPC H01F 27/022; H01F 27/2852; H01F 27/327; H01F 27/24; H01F 27/292

(57) ABSTRACT

A coupled inductor includes a first conductive body, a second conductive body, and a molding body. The first conductive body includes a first lateral portion, a first top portion, and a second lateral portion. The first conductive body extends from the first lateral portion to the second lateral portion via the first top portion. The second conductive body includes a third lateral portion, a second top portion, and a fourth lateral portion. The second conductive body extends from the third lateral portion to the fourth lateral portion via the second top portion. The molding body encapsulates the first lateral portion, the first top portion, and the second lateral portion of the first conductive body. At least one material is filled in a first space between a first bending portion of the first conductive body and a first bending portion of the second conductive body.

### CROSS REFERENCE TO RELATED APPLICATIONS

This application continuation-in-part of U.S. application Ser. No. 18/918,160, filed on Oct. 17, 2024, which claims the benefit of U.S. Provisional Application No. 63/649,331, filed on May 18, 2024, and claims the benefit of U.S. Provisional Application No. 63/544,450, filed on Oct. 17, 2023. The contents of these applications are incorporated herein by reference.

### BACKGROUND OF THE INVENTION

### 1. Field of the Invention

The present invention relates to a coupled inductor, and in particular to, a structure of coupled inductor.

### 2. Description of the Related Art

A conventional coupled inductor has two laterally-placed pillars, wherein a coil is wound on each of the two laterally-placed pillars. Such a design sacrifices the volume of the magnetic material to achieve the desired coefficient value. As a result, it is not suitable for a design that requires a smaller size.

Leakage inductance is an inherent characteristic of transformers or inductors, caused by imperfect magnetic coupling between windings, which reduces signal transfer efficiency. Although often considered undesirable, leakage inductance has practical applications in resonant converters, radio frequency (RF) transformers, magnetic amplifiers, and inductive sensors.

Therefore, a better solution for controlling leakage inductance is needed to resolve the issues mentioned above.

### SUMMARY OF THE INVENTION

The present invention provides a coupled inductor. The coupled inductor includes a first conductive body, a second conductive body, and a molding body.

The first conductive body includes a first lateral portion, a first top portion, and a second lateral portion. The first conductive body extends from the first lateral portion to the second lateral portion via the first top portion. The first conductive body further includes a first terminal portion that is bent from the first lateral portion and extends in a direction away from the second lateral portion and a second terminal portion that is bent from the second lateral portion and extends in a direction away from the first lateral portion.

The second conductive body includes a third lateral portion, a second top portion, and a fourth lateral portion. The second conductive body extends from the third lateral portion to the fourth lateral portion via the second top portion. The second conductive body further includes a third terminal portion that is bent from the third lateral portion and extends in a direction towards the fourth lateral portion and a fourth terminal portion that is bent from the fourth lateral portion and extends in a direction towards the third lateral portion.

The molding body encapsulates the first lateral portion, the first top portion, and the second lateral portion of the first conductive body.

At least one material is filled in a first space between an inner surface of a first bending portion of the first conductive body and an outer surface of a first bending portion of the second conductive body.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a view of a coupled inductor according to one embodiment of the present invention.

FIG. 2 shows a view of a coupled inductor according to one embodiment of the present invention.

FIG. 3 shows a view of a coupled inductor according to one embodiment of the present invention.

FIG. 4 shows a view of a coupled inductor according to one embodiment of the present invention.

FIG. 5 shows a view of an electrode structure of a coupled inductor according to one embodiment of the present invention.

FIG. 6 shows a view of an electrode structure of a coupled inductor according to one embodiment of the present invention.

FIG. 7A shows a view of a first space of a coupled inductor according to one embodiment of the present invention.

FIG. 7B shows a view of the coupled inductor in FIG. 7A.

FIG. 7C shows a view of the first space of a coupled inductor according to one embodiment of the present invention.

FIG. 7D shows a view of the first space of a coupled inductor according to one embodiment of the present invention.

FIG. 8 shows a view of a cuboid of a coupled inductor according to one embodiment of the present invention.

FIG. 9 shows a view of the side surfaces of terminal portions of a second conductive body of a coupled inductor according to one embodiment of the present invention.

FIG. 10 shows a view of the side surfaces of terminal portions of a second conductive body of a coupled inductor according to one embodiment of the present invention.

FIG. 11A shows a coupled inductor according to another embodiment of the present invention.

FIG. 11B is a U-shape leakage inductance control device for controlling the leakage inductance of the coupled inductor in FIG. 11A.

FIG. 12 shows a view of a coupled inductor according to one embodiment of the present invention.

FIG. 13 shows that the magnetic core and the molding body of a coupled inductor are made of the same material according to one embodiment of the present invention.

FIG. 14 shows that the magnetic core and the molding body of a coupled inductor are made of the different materials according to one embodiment of the present invention.

FIG. 15A shows that a plurality of coupled inductors are packed in a single package according to one embodiment of the present invention.

FIG. 15B shows that a plurality of coupled inductors are packed in a single package according to one embodiment of the present invention.

FIG. 16 shows a design to avoid short circuits of a plurality of coupled inductors according to one embodiment of the present invention.

FIG. 17 shows a design to avoid short circuits of a plurality of coupled inductors according to one embodiment of the present invention.

FIG. 18 shows a view of the side filleting of two adjacent coupled inductors according to one embodiment of the present invention.

FIG. 19A shows a view of a coupled inductor according to one embodiment of the present invention.

FIG. 19B shows a view of a coupled inductor according to one embodiment of the present invention.

### DETAILED DESCRIPTION

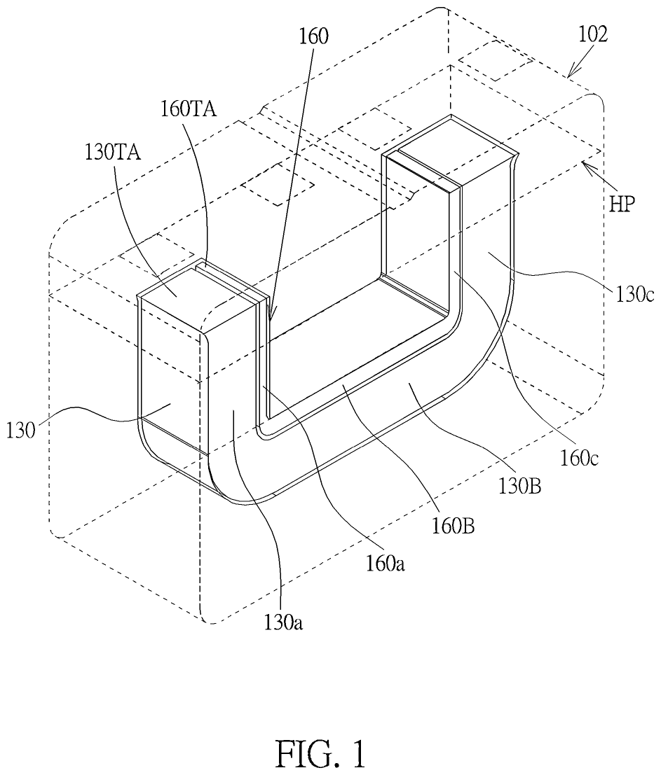

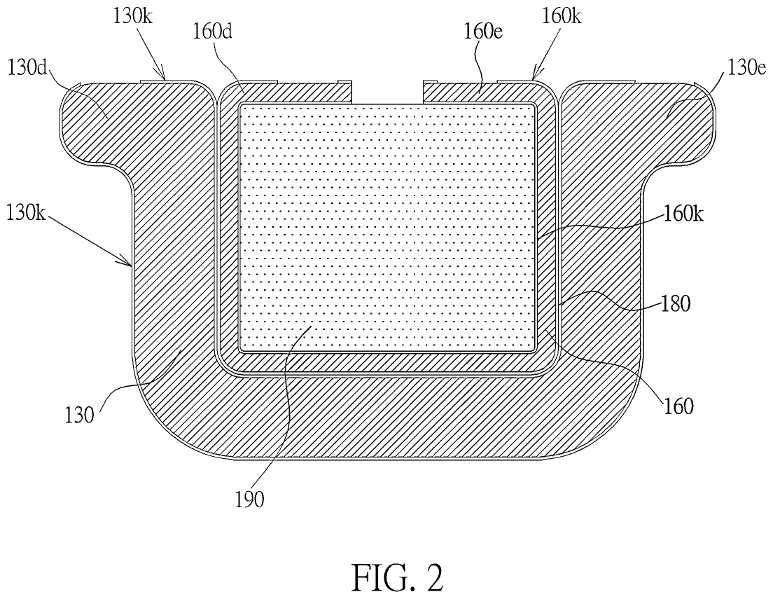

FIG. 1 shows a view of a coupled inductor according to one embodiment of the present invention. FIG. 2 shows a view of a coupled inductor according to one embodiment of the present invention. As shown in FIG. 1 and FIG. 2, the present invention discloses a coupled inductor. The coupled inductor includes a first conductive body 130, a second conductive body 160, a molding body 102. The first conductive body 130 includes a first lateral portion 130a, a first top portion 130b, and a second lateral portion 130c, wherein the first conductive body 130 extends from the first lateral portion 130a to the second lateral portion 130c via the first top portion 130b, and the first conductive body 130 further includes a first terminal portion 130d that is bent from the first lateral portion 130a and extends in a direction away from the second lateral portion 130c and a second terminal portion 130e that is bent from the second lateral portion 130c and extends in a direction away from the first lateral portion 130a.

A second conductive body 160 includes a third lateral portion 160a, a second top portion 160b, and a fourth lateral portion 160c. The second conductive body 160 extends from the third lateral portion 160a to the fourth lateral portion 160c via the second top portion 160b. The second conductive body 160 further includes a third terminal portion 160d that is bent from the third lateral portion 160a and extends in a direction towards the fourth lateral portion 160c and a fourth terminal portion 160e that is bent from the fourth lateral portion 160c and extends in a direction towards the third lateral portion 160a.

The molding body 102 encapsulates the first lateral portion 130a, the first top portion 130b, and the second lateral portion 130c of the first conductive body 130.

In one embodiment, as shown in FIG. 1, on a horizontal plane HP passing through the first lateral portion 130a and the third lateral portion 160a, a cross sectional area 130TA of the first lateral portion 130a cutting through a horizontal plane HP is larger than a cross sectional area 160TA of the third lateral portion 160a cutting through the horizontal plane.

In one embodiment, as shown in FIG. 1, the width of the first conductive body 130 is equal to the width of the second conductive body 160.

In one embodiment, as shown in FIG. 2, a magnetic core 190 is disposed in a hollow space of the second conductive body 160. In one embodiment, the molding body 102 encapsulates the first conductive body 130, the second conductive body 160 and the magnetic core 190.

In one embodiment, as shown in FIG. 2, the first conductive body 130 is fully encapsulated by a first insulating layer 130k, and the second conductive body 160 is fully encapsulated by a second insulating layer 160k. The first insulating layer 130k is attached to the second insulating layer 160k by an adhesive material 180.

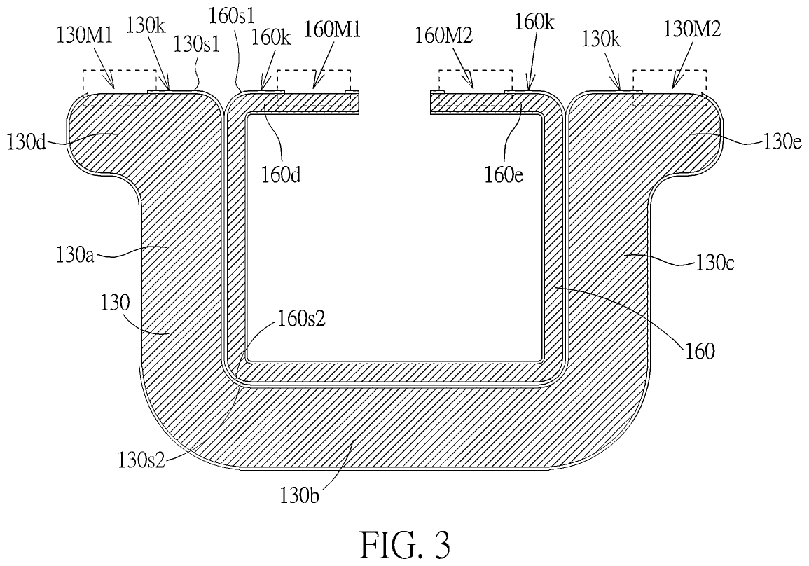

FIG. 3 shows a view of a coupled inductor according to one embodiment of the present invention. In one embodiment, as shown in FIG. 3, a bottom surface of the first terminal portion 130d is not covered by the first insulating layer 130k to expose a first inner metal portion 130M1 for forming a first electrode of the first conductive body 130.

In one embodiment, as shown in FIG. 3, a bottom surface of the second terminal portion 130e is not covered by the first insulating layer 130k to expose a second inner metal portion 130M2 for forming a second electrode of the first conductive body 130.

In one embodiment, as shown in FIG. 3, a bottom surface of the third terminal portion 160d is not covered by the second insulating layer 160k to expose a third inner metal portion 160M1 for forming a third electrode of the second conductive body 160.

In one embodiment, as shown in FIG. 3, a bottom surface of the fourth terminal portion 160e is not covered by the second insulating layer 160k to expose a fourth inner metal portion 160M2 for forming a fourth electrode of the second conductive body 160.

In one embodiment, the curvature radius of the inner surface of a first bending portion of the first conductive body 130 is greater than or equal to the curvature radius of the outer surface of a first bending portion of the second conductive body 160. The first bending portion of the first conductive body 130 is between the first terminal portion 130d and the first lateral portion 130a. The first bending portion of the second conductive body 160 is between the third terminal portion 160d and the third lateral portion 160a.

In one embodiment, the curvature radius of the inner surface of the second bending portion of the first conductive body 130 is greater than or equal to the curvature radius of the outer surface of the second bending portion of the second conductive body 160. The second bending portion of the first conductive body 130 is between the first top portion 130b and the first lateral portion 130a. The second bending portion of the second conductive body 160 is between the second top portion 160b and the third lateral portion 160a.

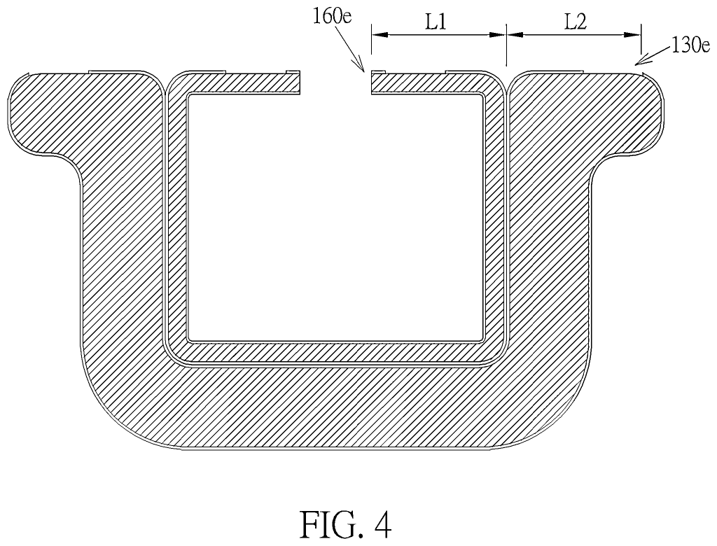

FIG. 4 shows a view of a coupled inductor according to one embodiment of the present invention. In one embodiment, as shown in FIG. 4, the length L1 of the fourth terminal portion 160e of the second conductive body 160 is greater or equal to the length L2 of the second terminal portion 130e of the first conductive body 130. In one embodiment, the length of the third terminal portion 160d of the second conductive body 160 is greater or equal to the length of the first terminal portion 130d of the first conductive body 130. The length L1 is greater or equal to the length L2, increasing the pressure resistance of the first conductive body 130 and the second conductive body 160.

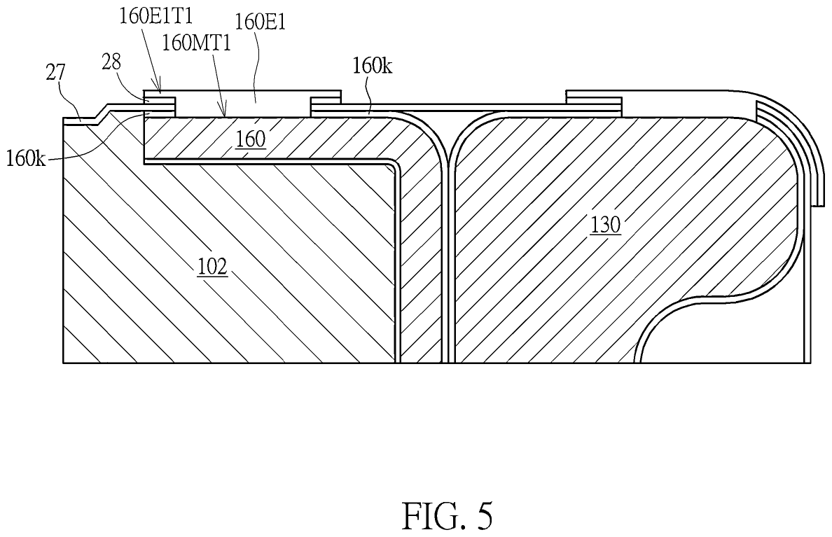

FIG. 5 shows a view of an electrode structure of a coupled inductor according to one embodiment of the present invention. As shown in FIG. 5, the present invention discloses the coupled inductor. A fourth electrode structure 160E1 is disposed on the fourth inner metal portion 160M2 and electrically connected to the second conductive body 160. A fourth top portion 160E1T1 of the fourth electrode structure 160E1 is located on a first lateral side of the fourth inner metal portion 160M2. The fourth top portion 160E1T1 of the fourth electrode structure 160E1 is attached to an insulating layer 027 of the molding body 102 through a silver-glue layer 028. In one embodiment, the fourth electrode structure 160E1 includes three metal layers Cu, Ni, Sn with Cu layer at the bottom and Sn layer at the top. In one embodiment, three metal layers Cu, Ni, Sn are formed by electroplating. In one embodiment, the fourth top portion 160E1T1 of the fourth electrode structure 160E1 is attached to the second insulating layer 160k of the second conductive body 160 and the insulating layer 027 of the molding body 102 through the silver-glue layer 028.

In the same way, a third electrode structure is disposed on the third inner metal portion 160M1 and electrically connected to the second conductive body 160. A third top portion of the third electrode structure is located on a first lateral side of the third inner metal portion 160M1. The third top portion of the third electrode structure is attached to an insulating layer 027 of the molding body 102 through a silver-glue layer 028. In one embodiment, the third electrode structure includes three metal layers Cu, Ni, Sn with Cu layer at the bottom and Sn layer at the top. In one embodiment, three metal layers Cu, Ni, Sn are formed by electroplating. In one embodiment, the third top portion of the third electrode structure is attached to the second insulating layer 160k of the second conductive body 160 and the insulating layer 027 of the molding body 102 through the silver-glue layer 028.

In the same way, a first electrode structure is disposed on the first inner metal portion 130M1 and electrically connected to the first conductive body 130. A first top portion of the first electrode structure is located on a first lateral side of the first inner metal portion 130M1. The first top portion of the first electrode structure is attached to an insulating layer 027 of the molding body 102 through a silver-glue layer 028. In one embodiment, the first electrode structure includes three metal layers Cu, Ni, Sn with Cu layer at the bottom and Sn layer at the top. In one embodiment, three metal layers Cu, Ni, Sn are formed by electroplating. In one embodiment, the first top portion of the first electrode structure is attached to the first insulating layer 130k of the first conductive body 130 and the insulating layer 027 of the molding body 102 through the silver-glue layer 028.

In the same way, a second electrode structure is disposed on the second inner metal portion 130M2 and electrically connected to the first conductive body 130. A second top portion of the second electrode structure is located on a first lateral side of the second inner metal portion 130M2. The second top portion of the second electrode structure is attached to an insulating layer 027 of the molding body 102 through a silver-glue layer 028. In one embodiment, the second electrode structure includes three metal layers Cu, Ni, Sn with Cu layer at the bottom and Sn layer at the top. In one embodiment, three metal layers Cu, Ni, Sn are formed by electroplating. In one embodiment, the second top portion of the second electrode structure is attached to the first insulating layer 130k of the first conductive body 130 and the insulating layer 027 of the molding body 102 through the silver-glue layer 028.

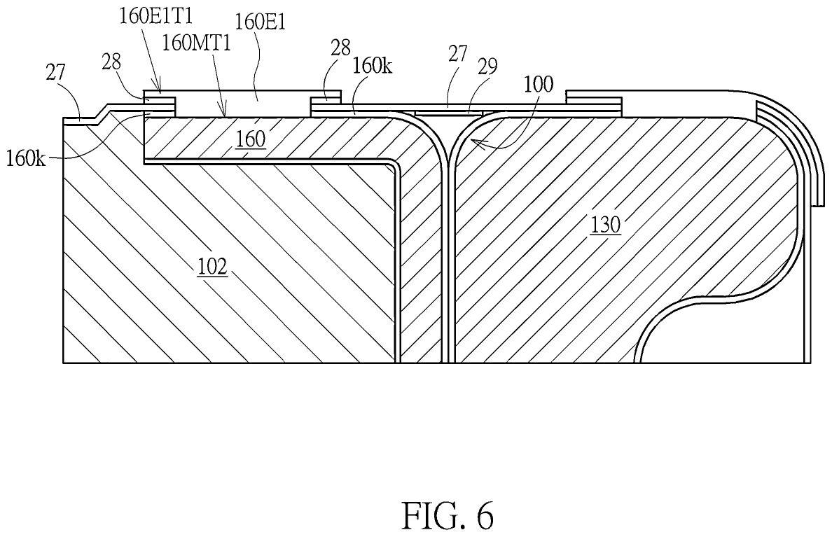

FIG. 6 shows a view of an electrode structure of a coupled inductor according to one embodiment of the present invention. Another insulating layer 029 is disposed under the insulating layer 027 between an inner surface of the first bending portion of the first conductive body 130 and an outer surface of the first bending portion of the second conductive body 160. In one embodiment, at least one material is filled in a first space 100 between an inner surface of a first bending portion of the first conductive body 130 and an outer surface of a first bending portion of the second conductive body 160.

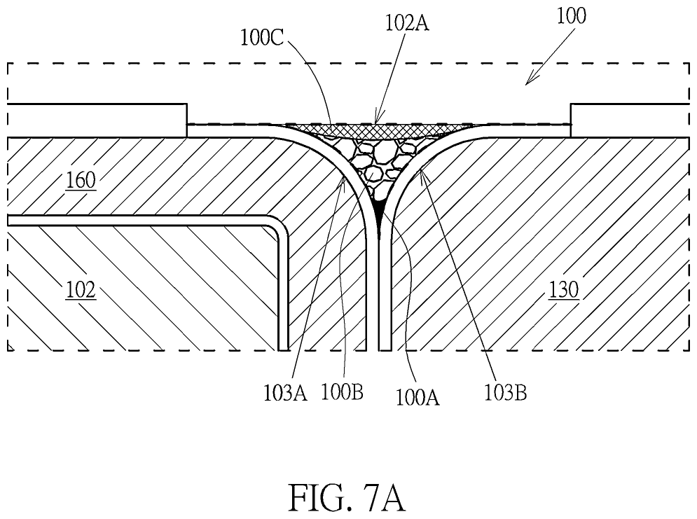

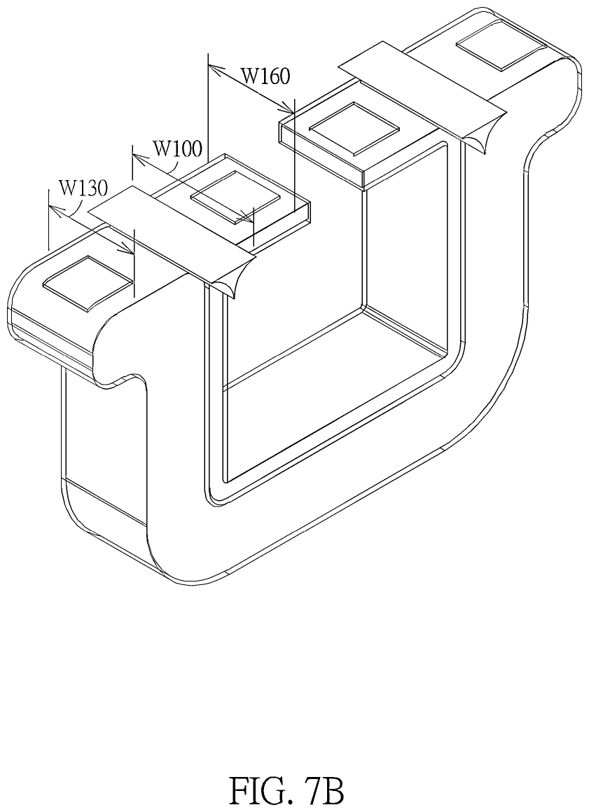

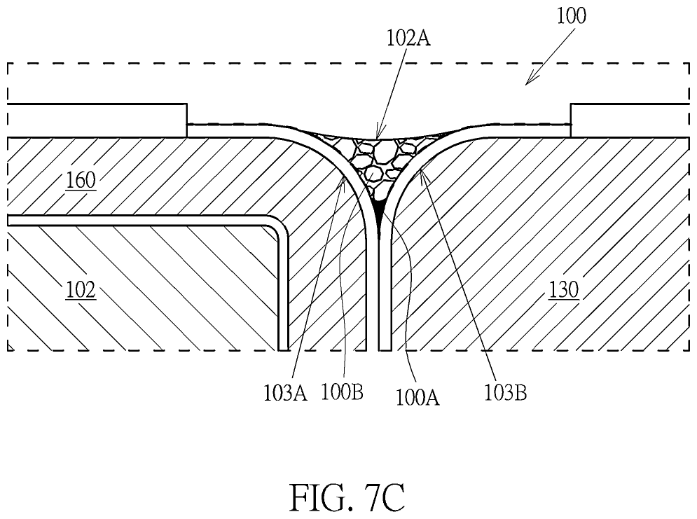

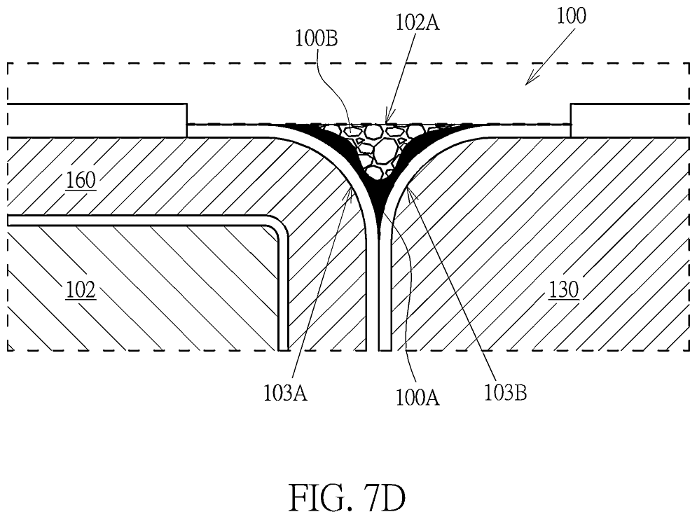

FIG. 7A shows a view of a first space 100 of a coupled inductor according to one embodiment of the present invention. At least one material 100A, 100B, and 100C is filled in the first space 100 between the inner surface 103B of a first bending portion of the first conductive body 130 and the outer surface 103A of a first bending portion of the second conductive body 160. The first space 100 may be surrounded by the inner surface 103B of the first bending portion of the first conductive body 130, the outer surface 103A of the first bending portion of the second conductive body 160, and a bottom surface 102A of the molding body 102. The first space 100 may be filled with a plurality of materials 100A, 100B, and 100C, but the embodiment is not limited thereto. The depth and the composition of the materials can be modified to control the leakage inductance of the coupled inductor of the embodiment. In an embodiment, the plurality of materials 100A, 100B, and 100C include different compositions. In one embodiment, the materials 100A, 100B, and 100C may comprise members selected from a group comprising polymer, oxide, ceramic material and magnetic material. In an embodiment, the magnetic permeability (μ) of the material 100A, 100B, and 100C may be 1.0-60.0 and may be smaller than the magnetic permeability (μ) of the molding body.

FIG. 7B shows a view of the coupled inductor in FIG. 7A. In one embodiment, the width W100 of the first space 100 is greater than or equal to the width W130 of the first conductive body 130. In one embodiment, the width W100 of the first space 100 is greater than or equal to the width W160 of the second conductive body 160. In one embodiment, the width W130 of the first conductive body 130 may be equal to the width W160 of the second conductive body 160.

FIG. 7C shows a view of the first space 100 of a coupled inductor according to one embodiment of the present invention. At least one material 100A and 100B is filled in the first space 100 between the inner surface 103B of a first bending portion of the first conductive body 130 and the outer surface 103A of a first bending portion of the second conductive body 160. The first space 100 may be surrounded by the inner surface 103B of the first bending portion of the first conductive body 130, the outer surface 103A of the first bending portion of the second conductive body 160, and a bottom surface 102A of the molding body 102. The first space 100 may be filled with a plurality of materials 100A and 100B, but the embodiment is not limited thereto. The depth and the composition of the materials can be modified to control the leakage inductance of the coupled inductor of the embodiment. In one embodiment, the materials 100A and 100B may comprise members selected from a group comprising polymer, oxide, ceramic material and magnetic material.

FIG. 7D shows a view of the first space 100 of a coupled inductor according to one embodiment of the present invention. At least one material 100A and 100B is filled in the first space 100 between the inner surface 103B of a first bending portion of the first conductive body 130 and the outer surface 103A of a first bending portion of the second conductive body 160. The first space 100 may be surrounded by the inner surface 103B of the first bending portion of the first conductive body 130, the outer surface 103A of the first bending portion of the second conductive body 160, and a bottom surface 102A of the molding body 102. The first space 100 may be filled with a plurality of materials 100A and 100B, but the embodiment is not limited thereto. The depth and the composition of the materials can be modified to control the leakage inductance of the coupled inductor of the embodiment. In one embodiment, the materials 100A and 100B may comprise members selected from a group comprising polymer, oxide, ceramic material and magnetic material.

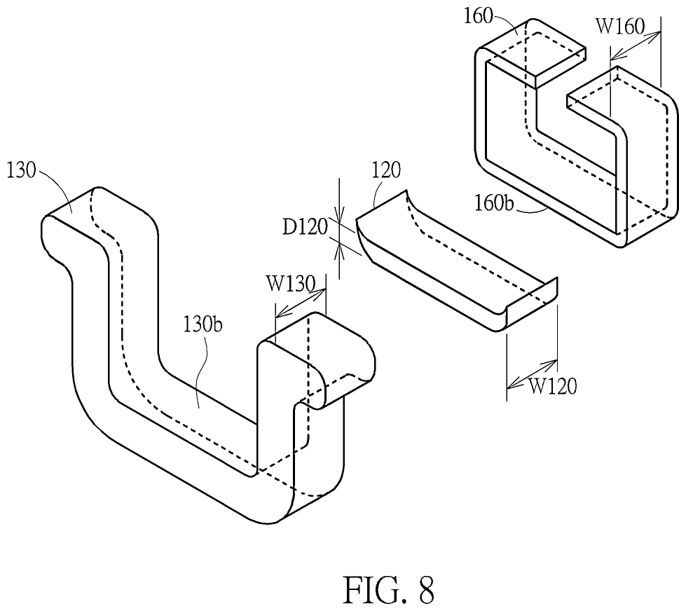

FIG. 8 shows a view of a cuboid 120 of a coupled inductor according to one embodiment of the present invention. In one embodiment, the cuboid 120 is disposed between the first top portion 130b and the second top portion 160b. In one embodiment, the width W120 of the cuboid 120 is less than or equal to the width W160 of the second conductive body 160. In one embodiment, the width W120 of the cuboid 120 is less than or equal to the width W130 of the first conductive body 130. The cuboid 120 can be attached to the first insulating layer 130k by an adhesive material and attached to the second insulating layer 160k by the adhesive material. The depth D120 and material of the cuboid 120 may be modified to control the leakage inductance of the coupled inductor. In one embodiment, the material of the cuboid 120 may be a polymer, an oxide, a ceramic material or a magnetic material.

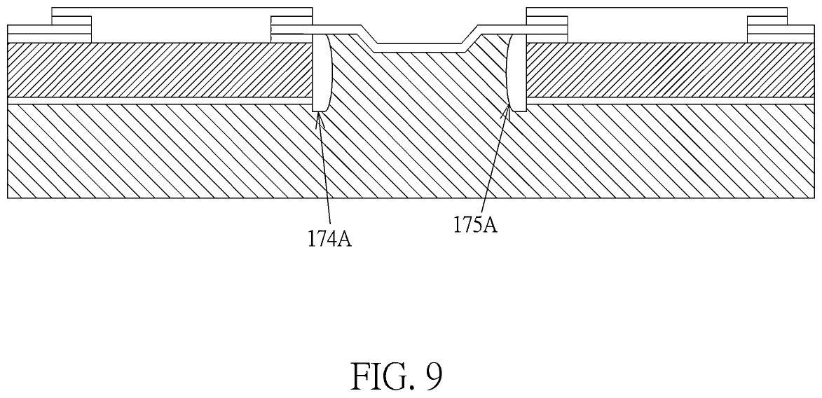

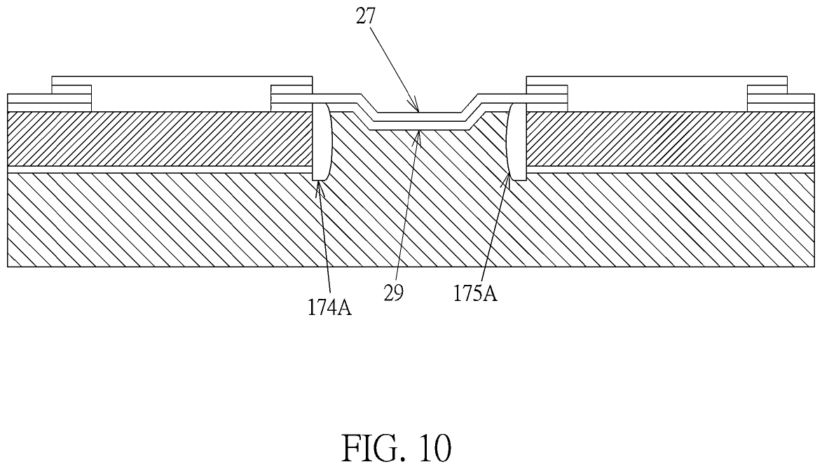

FIG. 9 shows a view of the side surfaces of terminal portions of a second conductive body of a coupled inductor according to one embodiment of the present invention. FIG. 10 shows a view of the side surfaces of terminal portions of a second conductive body of a coupled inductor according to one embodiment of the present invention. In one embodiment, as shown in FIG. 9 and FIG. 10, the first terminal side portion 174A inside the second conductive body 160 and the second terminal side portion 175A inside the second conductive body 160 are coated with an insulating material. The insulating material may be a polymer material, an oxide, a ceramic material or a magnetic material. The insulating material helps to insulate the second conductive body 160 from the molding body 102.

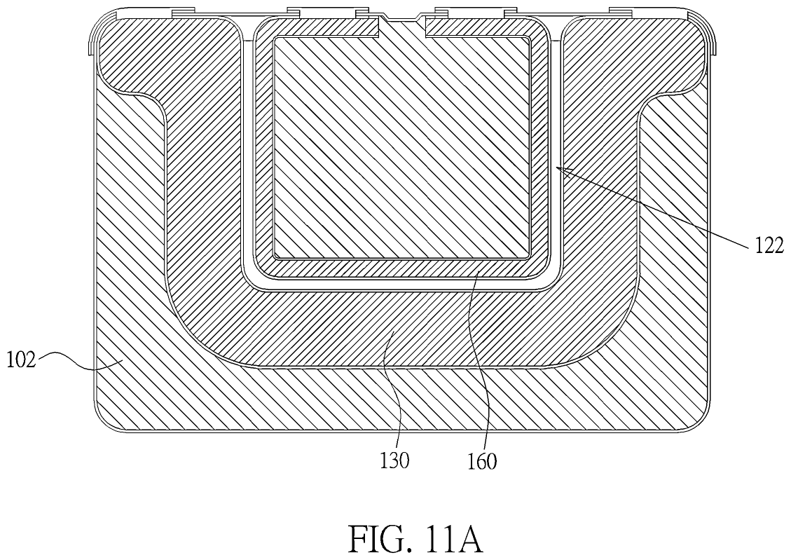

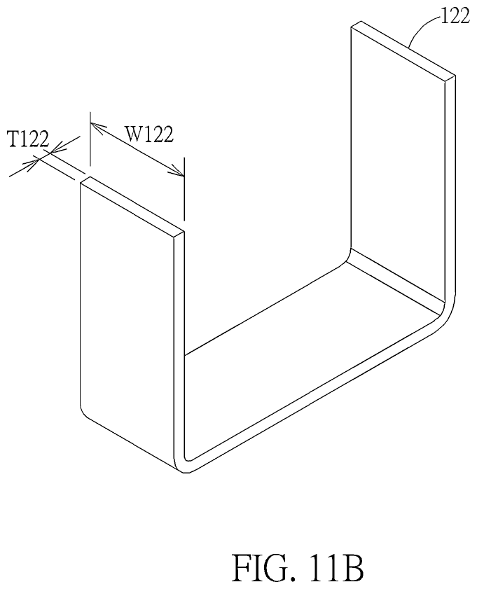

FIG. 11A shows a coupled inductor according to another embodiment of the present invention. FIG. 11B is a U-shape leakage inductance control device 122 for controlling the leakage inductance of the coupled inductor in FIG. 11A. As shown in FIG. 11A, the U-shape leakage inductance control device 122 for controlling leakage inductance is placed inside the molding body 102, where the U-shape leakage inductance control device 122 is between the first conductive body 130 and the second conductive body 160. In one embodiment, the width W122 of the U-shape leakage inductance control device 122 is less than or equal to the width W130 of the first conductive body 130. In one embodiment, the width W122 of the U-shape leakage inductance control device 122 is less than or equal to the width W160 of the second conductive body 160. Leakage inductance, transient inductance and/or coupling coefficient between the first conductive body 130 and the second conductive body 160 may be adjusted through modifying the thickness T122 and material of the U-shape leakage inductance control device 122. The U-shape leakage inductance control device 122 may be made from polymer materials, oxides, ceramics, magnetic materials or insulating materials. In an embodiment, the magnetic permeability (μ) of the U-shape leakage inductance control device 122 may be 1.0-60.0, and the thickness T122 of the U-shape leakage inductance control device 122 may be 0.05-1.0 mm.

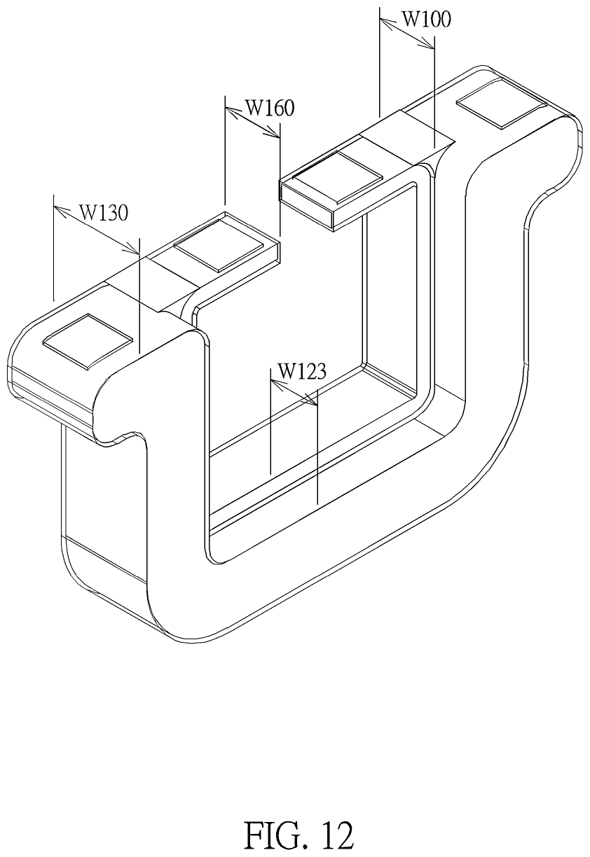

FIG. 12 shows a view of a coupled inductor according to one embodiment of the present invention. As shown in FIG. 12, the width W160 of the second conductive body 160 is less than the width W130 of the first conductive body 130. In one embodiment, the width W100 of the first space 100 is equal to the width W160 of the second conductive body 160. Therefore, the leakage inductance or coupling coefficient can be finely adjusted by modifying the width W123 of the non-overlapping area between the first conductive body 130 and the second conductive body 160.

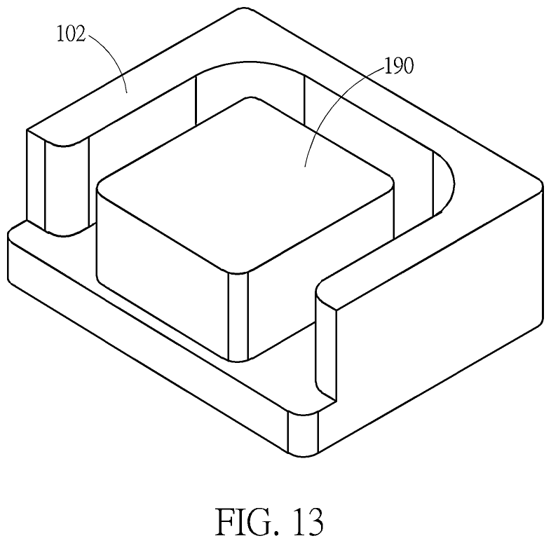

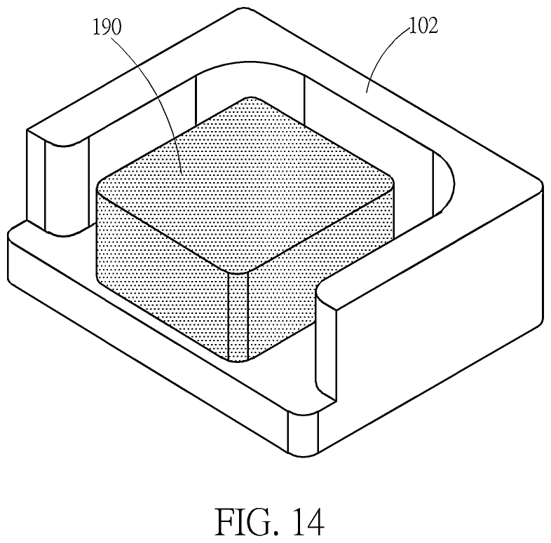

FIG. 13 shows that the magnetic core 190 and the molding body 102 of a coupled inductor are made of the same material according to one embodiment of the present invention. FIG. 14 shows that the magnetic core 190 and the molding body 102 of a coupled inductor are made of the different materials according to one embodiment of the present invention. As shown in FIG. 13, the magnetic core 190 and molding body 102 are made by the same material, wherein the material can be amorphous powder, nanocrystalline powder, carbonyl iron powder, alloy powder, Hi-Flux, Sendust, MPP or Ferrite. The composition can be C, Si, Cr, Fe, B, Co, Nb (Niobium) or Ni. The magnetic core 190 and molding body 102 are formed by pressure molding at room temperature. As shown in FIG. 14, the magnetic core 190 and the molding body 102 are made by the different material. There is an insulating adhesive layer all around for assembly and adhesion of the first conductive body 130 and the second conductive body 160. The material of the magnetic core 190 can be amorphous powder, nanocrystalline powder, carbonyl iron powder, alloy powder, Hi-Flux, Sendust, MPP or Ferrite. The composition can be C, Si, Cr, Fe, B, Co, Nb (niobium) or Ni. The magnetic core 190 is usually formed by pressing the mold at normal temperature and then sintering it at high temperature. The molding body 102 can be amorphous powder, nanocrystalline powder, carbonyl iron powder, alloy powder, Hi-Flux, Sendust, MPP or Ferrite. The composition can be C, Si, Cr, Fe, B, Co, Nb (niobium) or Ni. It is formed by pressure molding at room temperature.

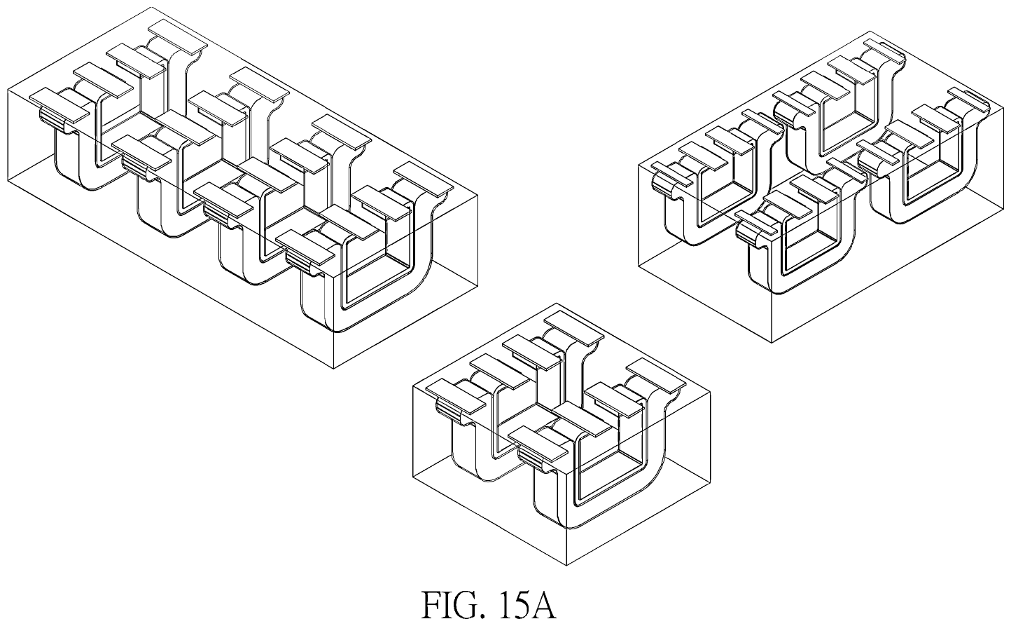

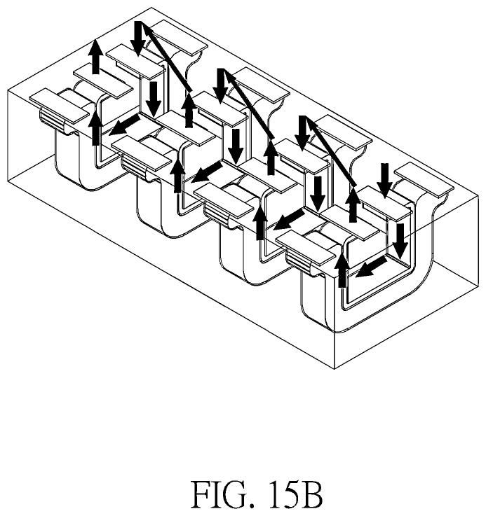

FIG. 15A shows that a plurality of coupled inductors are packed in a single package according to one embodiment of the present invention. The plurality of coupled inductors can be arranged in a row, in a column, or in a matrix as shown in FIG. 15A. However, if the gaps of the coupled inductors are too small, short circuits of the first conductive body 130 or the second conductive body 160 may occur. Therefore, a design for the electrodes is desired.

FIG. 15B shows that a plurality of coupled inductors are packed in a single package according to one embodiment of the present invention. The plurality of coupled inductors can be arranged in a row, in a column, or in a matrix as shown in FIG. 15A. When the plurality of coupled inductors are connected in series, the current can flow through the third electrode, the third lateral portion 160a, the second top portion 160b, the fourth lateral portion 160c, and the fourth electrode. Then, after the fourth electrode of the coupled inductor and the third electrode of the adjacent coupled inductor are welded together, the current may flow from the fourth electrode of the coupled inductor to the third electrode of the adjacent coupled inductor, and thus the plurality of coupled inductors are series connected as shown in FIG. 15B.

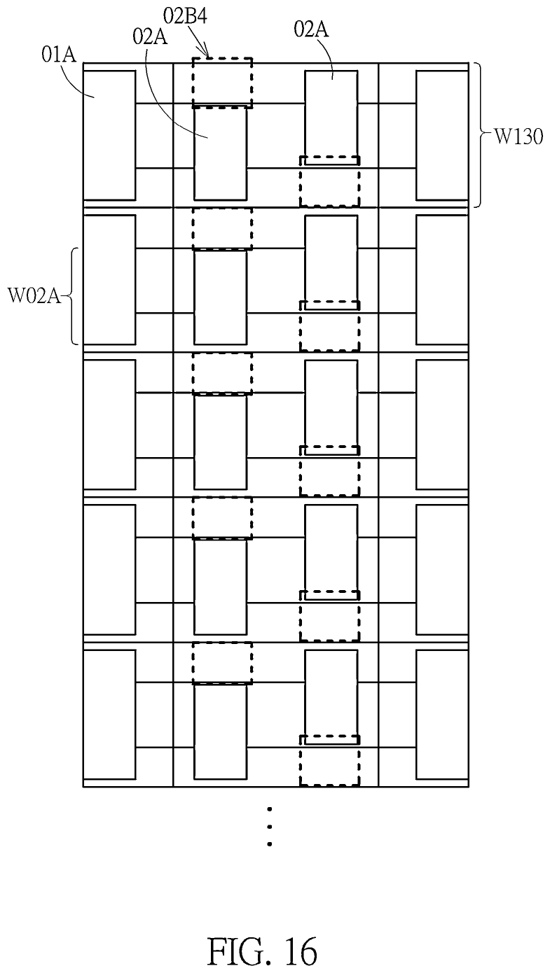

FIG. 16 shows a design to avoid short circuits of a plurality of coupled inductors according to one embodiment of the present invention. In one embodiment, a bottom surface of the first terminal portion 130d and the second terminal portion 130e is not covered by the first insulating layer 130k to expose a first inner metal portion 130M1 and a second inner metal portion 130M2 for forming first and second electrodes 01A of the first conductive body 130. In one embodiment, a bottom surface of the third terminal portion 160d and the fourth terminal portion 160e is not covered by the second insulating layer 160k to expose a third inner metal portion 160M1 and a fourth inner metal portion 160M2 for forming third and fourth electrodes 02A of the second conductive body 160. A short circuit between two third electrodes 02A or two fourth electrodes 02A may occur if the gap between two adjacent coupled inductors is too small. To prevent this, the widths W130 of the third and fourth electrodes 02A are reduced to new widths W02A, creating non-overlapping areas 02B4 and avoiding short circuits among the plurality of coupled inductors. In an embodiment, the third electrode includes a third rectangular portion and the fourth electrode includes a fourth rectangular portion. A first gap 02B4 is formed between a lower edge of the third rectangular portion and a lower edge of the molding body 102, and a second gap 02B4 is formed between an upper edge of the fourth rectangular portion and an upper edge of the molding body 102.

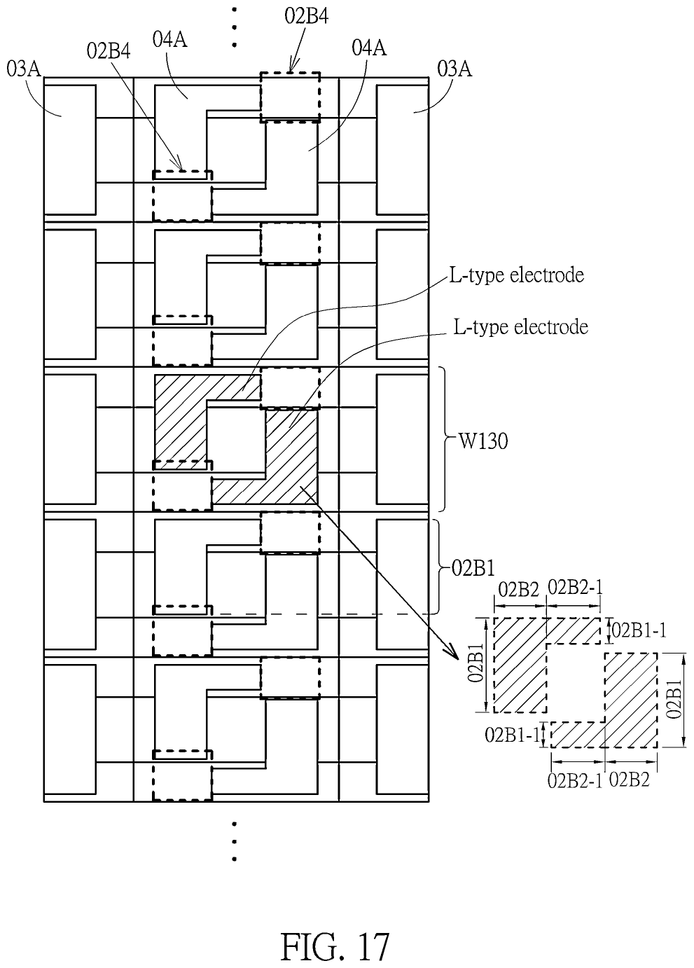

FIG. 17 shows a design to avoid short circuits of a plurality of coupled inductors according to one embodiment of the present invention. In one embodiment, a bottom surface of the first terminal portion 130d and the second terminal portion 130e is not covered by the first insulating layer 130k to expose a first inner metal portion 130M1 and a second inner metal portion 130M2 for forming first and second electrodes 03A of the first conductive body 130. In one embodiment, a bottom surface of the third terminal portion 160d and the fourth terminal portion 160e is not covered by the second insulating layer 160k to expose a third inner metal portion 160M1 and a fourth inner metal portion 160M2 for forming third and fourth electrodes 04A of the second conductive body 160. A short circuit between two third electrodes 04A or two fourth electrodes 04A may occur if the gap between two adjacent coupled inductors is too small. To prevent this, the widths W130 of the third and fourth electrodes 04A are reduced to new widths 02B1, creating non-overlapping areas 02B4 and avoiding short circuits among the plurality of coupled inductors. In one embodiment, the shape of the third and fourth electrodes 04A are L-type, combined by a first rectangle with length 02B1 and width 02B2 and a second rectangle with length 02B2-1 and width 02B1-1. The L-type electrodes avoid short circuits and make the layout of the plurality of coupled inductors more efficient in constant area. Due to the L-type electrodes, the third electrode of the coupled inductance can be welded with the fourth electrode of the adjacent coupled inductor easily. Therefore, the current may flow through the third electrode, the third lateral portion 160a, the second top portion 160b, the fourth lateral portion 160c, and the fourth electrode. Then, the current flow from the fourth electrode of the coupled inductor to the third electrode of the adjacent coupled inductor, and thus the plurality of coupled inductors using L-type electrodes are series connected as shown in FIG. 15B.

In an embodiment, the lengths of the first and second electrodes 03A of the first conductive body 130 are larger than the width of the first conductive body 130. The lengths of the third and fourth electrodes 04A of the second conductive body 160 are larger than the width of the second conductive body 160. In an embodiment, the lengths of the first and second electrodes 03A of the first conductive body 130 are smaller than the width W130 of the molding body 102, and the lengths 02B1 of the third and fourth electrodes 04A of the second conductive body 160 are smaller than the width W130 of the molding body 102. In an embodiment, the lengths of the first and second electrodes 03A of the first conductive body 130 are larger than the lengths 02B1 of the third and fourth electrodes 04A of the second conductive body 160. The third and fourth electrodes 04A of the second conductive body 160 cover partially or completely the bottom surface of the second conductive body 160. The third and fourth electrodes 04A of the second conductive body 160 may include bottom groove of the molding body 102.

In an embodiment, the curvature angle of a first side of the bottom surface of the molding body 102 is larger than or equal to the curvature angle of the first terminal portion 130d of the first conductive body 130. In an embodiment, the curvature angle of a second side of the bottom surface of the molding body 102 is larger than or equal to the curvature angle of the second terminal portion 130e of the first conductive body 130. In an embodiment, the bottom curvature angle of the first terminal portion 130d of the first conductive body 130 is larger than or equal to the top curvature angle of the first terminal portion 130d of the first conductive body 130. The bottom curvature angle of the second terminal portion 130e of the first conductive body 130 is larger than or equal to the top curvature angle of the second terminal portion 130e of the first conductive body 130. In an embodiment, the curvature angles of the first side and the second side of the bottom surface of the molding body 102 are larger than or equal to 0.3. The bottom curvature angles of the first terminal portion 130d and the second terminal portion 130e of the first conductive body 130 are larger than the width W130 of the first conductive body 130, thus effectively saving the spacing between two adjacent coupled inductors in a layout.

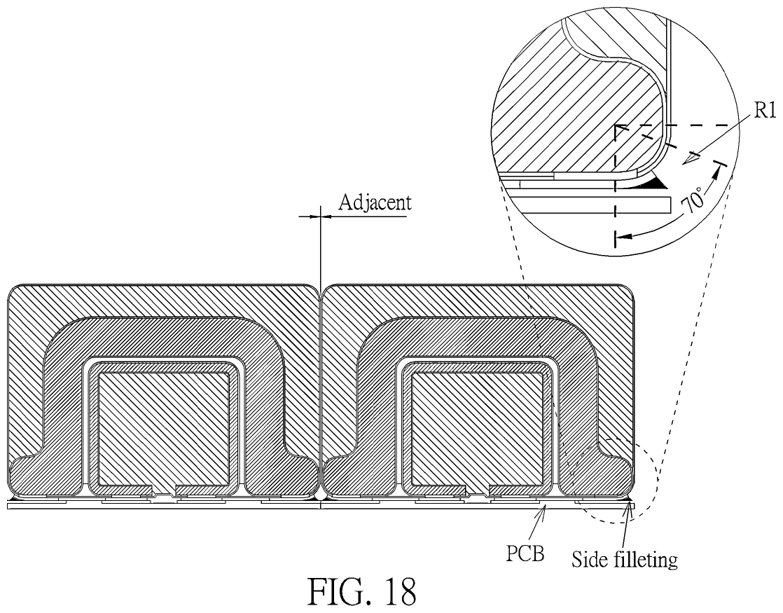

FIG. 18 shows a view of the side filleting of two adjacent coupled inductors according to one embodiment of the present invention. A bottom surface of the first terminal portion 130d is not covered by the first insulating layer 130k to expose a first inner metal portion 130M1 for forming a first electrode of the first conductive body 130. In one embodiment, a bottom surface of the second terminal portion 130e is not covered by the first insulating layer 130k to expose a second inner metal portion 130M2 for forming a second electrode of the first conductive body 130. Side filleting occurs between the first electrode of the first conductive body 130 of a coupled inductor and the second electrode of the first conductive body 130 of the adjacent coupled inductor. A curved portion of the first electrode spans less than 70 degrees of a curvature angle R1 of the first terminal portion 130d. The curvature angle R1 in the first electrode of the first conductive body 130 of a coupled inductor is set to 70 degree to reduce side filleting and to efficiently use the PCB (printed circuit board) landpattern. The coupled inductor and the adjacent coupled inductor should not be short circuited through the first electrode of the coupled inductor and the second electrode of the adjacent coupled inductor. Therefore, the limited curvature angle R1 make the weld side filleting short to not beyond the boundary of the coupled inductor and the adjacent coupled inductor.

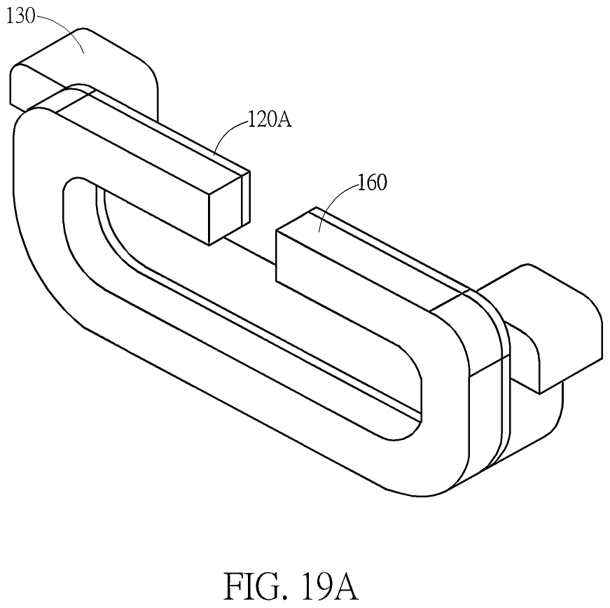

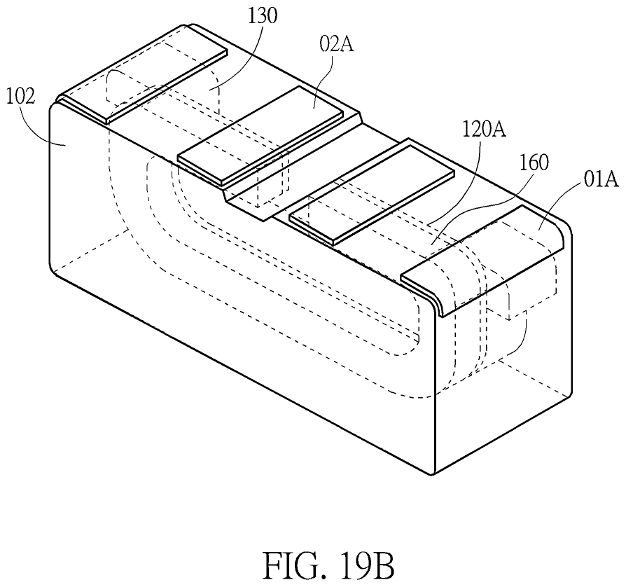

FIG. 19A shows a view of a coupled inductor according to one embodiment of the present invention. In one embodiment, the first conductive body 130 and second conductive body 160 are overlapped through a leakage inductance control device 120A for controlling leakage inductance, and the leakage inductance control device 120A is disposed between the first conductive body and the second conductive body. In one embodiment, the shape of the leakage inductance control device 120A is the same as the second conductive body 160 with different width.

FIG. 19B shows a view of a coupled inductor according to one embodiment of the present invention. In one embodiment, a bottom surface of the first terminal portion 130d is not covered by the first insulating layer 130k to expose a first inner metal portion 130M1 for forming a first electrode 01A of the first conductive body 130. In one embodiment, a bottom surface of the second terminal portion 130e is not covered by the first insulating layer 130k to expose a second inner metal portion 130M2 for forming a second electrode 01A of the first conductive body 130. In one embodiment, a bottom surface of the third terminal portion 160d is not covered by the second insulating layer 160k to expose a third inner metal portion 160M1 for forming a third electrode 02A of the second conductive body 160. In one embodiment, a bottom surface of the fourth terminal portion 160e is not covered by the second insulating layer 160k to expose a fourth inner metal portion 160M2 for forming a fourth electrode 02A of the second conductive body 160.

In one embodiment, the curvature radius of the inner surface of a first bending portion of the first conductive body 130 is greater than or equal to the curvature radius of the outer surface of a first bending portion of the second conductive body 160. The first bending portion of the first conductive body 130 is between the first terminal portion 130d and the first lateral portion 130a. The first bending portion of the second conductive body 160 is between the third terminal portion 160d and the third lateral portion 160a.

In one embodiment, the curvature radius of the inner surface of the second bending portion of the first conductive body 130 is greater than or equal to the curvature radius of the outer surface of the second bending portion of the second conductive body 160. The second bending portion of the first conductive body 130 is between the first top portion 130b and the first lateral portion 130a. The second bending portion of the second conductive body 160 is between the second top portion 160b and the third lateral portion 160a.

In summary, the leakage inductance of the coupled inductor can be finely controlled by using the coupled inductors in FIG. 7A, FIG. 7B, FIG. 7C, FIG. 7D, FIG. 8, FIG. 11A, FIG. 11B, FIG. 12, FIG. 19A and/or FIG. 19B. Moreover, the widths W130 of the third and fourth electrodes 02A are reduced to new widths W02A or 02B1, creating non-overlapping areas 02B4 and preventing short circuits among the plurality of coupled inductors.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coupled inductor, comprising:
a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion and a second terminal portion that is bent from the second lateral portion and extends in a direction away from the first lateral portion;
a second conductive body, comprising a third lateral portion, a second top portion, and a fourth lateral portion, wherein the second conductive body extends from the third lateral portion to the fourth lateral portion via the second top portion, wherein the second conductive body further comprises a third terminal portion that is bent from the third lateral portion and extends in a direction towards the fourth lateral portion and a fourth terminal portion that is bent from the fourth lateral portion and extends in a direction towards the third lateral portion; and
a molding body, encapsulating the first lateral portion, the first top portion, and the second lateral portion of the first conductive body;
wherein at least one material is filled in a first space between an inner surface of a first bending portion of the first conductive body and an outer surface of a first bending portion of the second conductive body.

2. The coupled inductor according to claim 1, wherein a magnetic core is disposed in a hollow space of the second conductive body.

3. The coupled inductor according to claim 2, wherein the molding body encapsulates the first conductive body, the second conductive body and the magnetic core.

4. The coupled inductor according to claim 1, wherein the at least one material comprises a magnetic material.

5. The coupled inductor according to claim 1, wherein the at least one material is selected from a group consisting of a polymer, an oxide, a ceramic material, and a magnetic material.

6. The coupled inductor according to claim 1, wherein the first conductive body is fully encapsulated by a first insulating layer, and the second conductive body is fully encapsulated by a second insulating layer, wherein the first insulating layer is attached to the second insulating layer by an adhesive material.

7. The coupled inductor according to claim 1, wherein a cross sectional area of the first lateral portion cutting through a horizontal plane is larger than a cross sectional area of the third lateral portion cutting through the horizontal plane.

8. The coupled inductor according to claim 1, wherein a width of the first conductive body is equal to a width of the second conductive body.

9. The coupled inductor according to claim 1, wherein a curvature radius of the inner surface of the first bending portion of the first conductive body is greater than or equal to a curvature radius of the outer surface of the first bending portion of the second conductive body.

10. The coupled inductor according to claim 1, wherein a curvature radius of an inner surface of a second bending portion of the first conductive body is greater than or equal to a curvature radius of an outer surface of a second bending portion of the second conductive body.

11. The coupled inductor according to claim 1, wherein a length of the third terminal portion of the second conductive body is greater or equal to a length of the first terminal portion of the first conductive body.

12. The coupled inductor according to claim 1, wherein two materials are filled in the first space between the inner surface of the first bending portion of the first conductive body and the outer surface of the first bending portion of the second conductive body.

13. The coupled inductor according to claim 12, wherein the two materials are selected from a group consisting of a polymer, an oxide, a ceramic material, and a magnetic material.

14. The coupled inductor according to claim 1, wherein three materials are filled in the first space between the inner surface of the first bending portion of the first conductive body and the outer surface of the first bending portion of the second conductive body.

15. The coupled inductor according to claim 14, wherein the three materials are selected from a group consisting of a polymer, an oxide, a ceramic material, and a magnetic material.

16. A coupled inductor, comprising:
a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion and a second terminal portion that is bent from the second lateral portion and extends in a direction away from the first lateral portion;
a second conductive body, comprising a third lateral portion, a second top portion, and a fourth lateral portion, wherein the second conductive body extends from the third lateral portion to the fourth lateral portion via the second top portion, wherein the second conductive body further comprises a third terminal portion that is bent from the third lateral portion and extends in a direction towards the fourth lateral portion and a fourth terminal portion that is bent from the fourth lateral portion and extends in a direction towards the third lateral portion; and
a molding body, encapsulating the first lateral portion, the first top portion, and the second lateral portion of the first conductive body;
wherein a leakage inductance control device is disposed between the first conductive body and the second conductive body.

17. The coupled inductor according to claim 16, wherein the leakage inductance control device is a U-shape leakage inductance control device, the leakage inductance control device is located between the first top portion and the second top portion, and extends along a direction toward the first terminal portion.

18. A coupled inductor, comprising:
a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion and a second terminal portion that is bent from the second lateral portion and extends in a direction away from the first lateral portion;
a second conductive body, comprising a third lateral portion, a second top portion, and a fourth lateral portion, wherein the second conductive body extends from the third lateral portion to the fourth lateral portion via the second top portion, wherein the second conductive body further comprises a third terminal portion that is bent from the third lateral portion and extends in a direction towards the fourth lateral portion and a fourth terminal portion that is bent from the fourth lateral portion and extends in a direction towards the third lateral portion; and
a molding body, encapsulating the first lateral portion, the first top portion, and the second lateral portion of the first conductive body;
wherein a third electrode and a fourth electrode of the second conductive body are formed on the third terminal portion and the fourth terminal portion respectively;
wherein the third electrode comprises a third rectangular portion and the fourth electrode comprises a fourth rectangular portion;
wherein a first gap is formed between a lower edge of the third rectangular portion and a lower edge of the molding body, and a second gap is formed between an upper edge of the fourth rectangular portion and an upper edge of the molding body.

19. The coupled inductor according to claim 18, wherein a third flank is extended from an upper side of the third rectangular portion towards the second gap, and a fourth flank is extended from a lower side of the fourth rectangular portion towards the first gap.

20. A coupled inductor, comprising:
a first conductive body, comprising a first lateral portion, a first top portion, and a second lateral portion, wherein the first conductive body extends from the first lateral portion to the second lateral portion via the first top portion, wherein the first conductive body further comprises a first terminal portion that is bent from the first lateral portion and extends in a direction away from the second lateral portion and a second terminal portion that is bent from the second lateral portion and extends in a direction away from the first lateral portion;
a second conductive body, comprising a third lateral portion, a second top portion, and a fourth lateral portion, wherein the second conductive body extends from the third lateral portion to the fourth lateral portion via the second top portion, wherein the second conductive body further comprises a third terminal portion that is bent from the third lateral portion and extends in a direction towards the fourth lateral portion and a fourth terminal portion that is bent from the fourth lateral portion and extends in a direction towards the third lateral portion; and
a molding body, encapsulating the first lateral portion, the first top portion, and the second lateral portion of the first conductive body;
wherein the first terminal portion comprises a curved portion, the curved portion comprise a curvature angle and is less than 70 degrees to vertical,
wherein a first electrode of the first conductive body is formed on the first terminal portion along a surface of the curved portion based on the curvature angle.
